(19) United States
(12) Patent Application Publication
(10) Pub. No.: US 2011/0102335 A1
(43) Pub. Date: May 5, 2011

(54) INPUT DEVICE, INPUT METHOD, PROGRAM, AND STORAGE MEDIUM

(76) Inventors: Kensuke Miyamura, Osaka (JP); Kozo Takahashi, Osaka (JP); Masaki Uehata, Osaka (JP); Shigenori Tanaka, Osaka (JP); Jun Nakata, Osaka (JP); Kazuki Takahashi, Osaka (JP); Takashi Taneyama, Osaka (JP)

(21) Appl. No.: 12/736,983

(22) PCT Filed: Apr. 17, 2009
(86) PCT No.: PCT/JP2009/057798

§ 371 Date: Dec. 22, 2010

(30) Foreign Application Priority Data
Jun. 2, 2008 (JP) 2008-144570

(51) Int. Cl. G06F 3/041

(52) U.S. Cl. 345/173

(57) ABSTRACT

An input device includes a display unit and a touch panel provided to the display unit. In at least one embodiment, the input device further includes: a finger image generation section which generates respective images of, among a plurality of fingers pressing on the touch panel, a first finger and a second finger adjacent to the first finger; and a display process section which displays on the display unit a plurality of input images corresponding to a distance between two images generated by the finger image generation section and respective sizes of the two images. This allows the input device including the touch panel to adjust, as a result of a single setting, the input images to be appropriate for sizes of fingers and a size of a hand of the user.

### TECHNICAL FIELD

The present invention relates to an input device including a touch panel, an input method, a program, and a storage medium.

### BACKGROUND ART

There are conventionally input devices having a display with a touch panel. Some of such input devices can display a UI screen on the display so as to allow a user to perform various operations by touching the UI screen. UI stands for “User Interface”. That is, the UI screen is a screen that the user touches directly or with an object to give an instruction for executing necessary process via the touch panel. This kind of input device is exemplified by an electronic music device. The electronic music device is a device that displays a keyboard, strings, or the like on the touch panel, and produces a sound to play music in response to a touch on them by the user with his/her finger.

An example of a technique that displays a keyboard of an electronic piano on the display is disclosed in Patent Literature 1.

The technique of Patent Literature 1 is to adjust the size of the entire keyboard in response to a press of a size adjusting button (an enlargement key or a reduction key). This causes the size of the entire keyboard to be adjusted to be appropriate for a size of a hand.

However, the technique disclosed in Patent Literature 1 enlarges or reduces the entire keyboard. As such, it is difficult to adjust the size of the keyboard at one time so as to be optimal for the user's finger width or hand size. Therefore, the user often has to repeat minor adjustments, with his/her hand put on the keyboard, by pressing the adjusting button several times. Moreover, since this technique is intended for the electronic piano, it cannot be applied to other music devices.

There are other electronic music devices that produce a sound in response to a touch with a finger on the touch panel. For example, Patent Literature 2 discloses a technique in which a musical score is displayed on a display and a sound corresponding to an area of the musical score touched by the user is produced. Specifically, the sound is produced in accordance with a musical note touched with the finger.

However, as described above, the technique of Patent Literature 2 is to produce a sound which corresponds to the area of the musical score that is pressed. As such, a musical performance by use of an actual musical instrument is not intended. Further, Patent Literature 2 does not mention adjusting the size of an input image.

Thus, no electronic music device is known in which a part, which is used for playing music or operating the electronic music device (hereinafter referred to as an “input image”), is displayed on the UI screen and can be adjusted by a single setting to have such a size that the user can comfortably play music.

Not only in the electronic music devices but also in other input devices provided with a touch panel, no technique is known that can adjust the size of the input image by a single setting so as to be appropriate for the finger width of the user. For example, no technique is known that can adjust the size of keys of on-screen keyboard in such a way that has been described above.

### Citation List

### [Patent Literature]

Patent Literature 1

Japanese Patent Application Publication Tokukai No. 2000-10563 A (Publication Date: Jan. 14, 2000)

Patent Literature 2

Japanese Patent Application Publication Tokukai No. 2007-34115 A (Publication Date: Feb. 8, 2007)

### SUMMARY OF INVENTION

As described above, the conventional input device including the touch panel is (i) the one that has to repeat minor adjustments of the input image so as to be appropriate for the finger width and the hand size of the user or (ii) the one that serves exclusively as a particular music device.

The present invention is achieved in view of the above problems, and an object of the present invention is to provide an input device, an input method, a program, and a storage medium that can adjust the input image by a single setting so as to have an optimal size that is appropriate for the finger width and the hand size of the user.

(Input Device)

In order to attain the above object, an input device of the present invention, which includes a display and a touch panel provided to the display, includes: image generation means for generating respective images of, among a plurality of fingers pressing on the touch panel, a first finger and an image of a second finger adjacent to the first finger; and display process means for displaying on the display a plurality of input images corresponding to a distance between two images generated by the image generation means and respective sizes of the two images.

According to the above configuration, the input device includes a display and a touch panel provided to the display.

The present input device also includes image generation means for generating respective images of, among a plurality of fingers, a first finger and a second finger adjacent to the first finger. In a case where the first finger is a forefinger, the second finger is, e.g., a middle finger. With this configuration, it is possible to separately generate images of fingers pressing on the touch panel. That is, in the aforementioned case, the input device generates an image of the forefinger and an image of the middle finger, respectively.

The present input device further includes display process means for displaying on the display a plurality of input images corresponding to a distance between two images generated by the image generation means and respective sizes of the two images. The distance between the two images here means, for example, a distance between the forefinger and the middle finger. The respective sizes of the two images mean, for example, transverse widths of the respective fingers. With this configuration, the input device displays on the display the input images corresponding to the distance between the forefinger and the middle finger and the transverse widths of the respective fingers, for example.

As described above, the present input device displays on the display the input images corresponding to the sizes of the user's fingers and the distance between the fingers. That is, the present input device can display the input images that have been adjusted to be appropriate for the size of the user's hand. The user performs an input operation via the touch panel by directly touching the input images.

An example of such an input device is an electronic musical instrument. For example, an electronic piano produces sounds in response to user's pressing on the input images represented as keys. In the present input device, the input images, which are represented as the keys, are displayed in positions where the user puts his/her fingers naturally. This prevents a possibility that the user happens to perform an input operation by erroneously touching other input images. In other words, this produces an effect of avoiding an erroneous operation. In a case where the present input device is realized as an electronic piano, the keys are provided in positions where the user puts his/her hand naturally. This allows the user to comfortably play music without pressing two keys by mistake.

Furthermore, the present input device can display, as a result of a single setting, the input images corresponding to the sizes of the user's fingers and the distance between the fingers. With this configuration, the user does not have to repeat minor adjustments with his/her hand put on the input image as in the conventional techniques. Therefore, an effect is produced that the setting can be made easily.

(Calculation of Width)

It is preferable that the input device of the present invention further includes: width calculating means for calculating out a given width of the plurality of input images based on the distance and the sizes, and the display process means displays the plurality of input images each having the width calculated out by the width calculating means.

According to the above configuration, the present input device further includes width calculating means for calculating a given width based on the aforementioned distance and sizes. Further, the display process means displays the plurality of input images each having the given width calculated out by the width calculating means. With this configuration, it is possible to simultaneously display the plurality of input images that have been adjusted to have equal widths.

(Calculation of Longitudinal Width and Transverse Width)

In the input device of the present invention, it is preferable that the width calculating means calculates out, based on the distance and the sizes, longitudinal widths and transverse widths of the plurality of input images, respectively, and the display process means displays the plurality of input images respectively having the longitudinal widths and the transverse widths calculated out by the width calculating means.

According to the above configuration, the present input device calculates, based on the distance and the sizes, the longitudinal widths and the transverse widths of the plurality of input images. Further, the display process means displays the plurality of input images respectively having the longitudinal widths and the transverse widths calculated out by the width calculating means. With this configuration, it is possible to display a plurality of input images adjusted to have equal longitudinal widths and equal transverse widths.

(Calculation of Distance)

It is preferable that the input device of the present invention further includes: distance calculating means for calculating out, based on the distance and the sizes, a distance between adjacent input images among the plurality of input images, and the display process means displays the plurality of input images so as to space the input images apart from each other at the distance calculated out by the distance calculating means.

According to the above configuration, the present input device further includes distance calculating means for calculating out, based on the distance and the sizes, a distance between adjacent input images among the plurality of input images. Further, the display process means displays the plurality of input images so as to space the input images apart from each other at the distance calculated out by the distance calculating means. With this configuration, it is possible to display the plurality of input images that are arranged evenly spaced apart.

(Photo Detecting Touch Panel)

Further, in the input device of the present invention, it is preferable that the touch panel be a photo detecting touch panel.

(Input Method)

An input method, which is executed by an input device which includes a display and a touch panel provided to the display, includes the steps of: generating respective images of, among a plurality of fingers pressing on the touch panel, a first finger and a second finger adjacent to the first finger; and displaying on the display a plurality of input images corresponding to a distance between two images generated by the image generation means and respective sizes of the two images.

(Program and Storage Medium)

The input device according to the present invention may be realized by a computer. In that case, a program causing a computer to function as each of the foregoing means to realize the input device in the computer and a computer readable storage medium in which the program is stored fall within the scope of the present invention.

As described above, in the present input device, the input images are arranged in the positions where the user puts his/her hand naturally. This prevents a possibility that the user happens to perform an input operation by erroneously touching other input images. In other words, this produces an effect of avoiding an erroneous operation. Furthermore, the present input device can display, as a result of a single setting, the input images corresponding to the sizes of the user's fingers and the distance between the fingers. With this configuration, the user does not have to repeat minor adjustments of the input images. Therefore, an effect is produced that the setting can be made easily.

### BRIEF DESCRIPTION OF DRAWINGS

FIG. 1 is a block diagram illustrating a configuration of a main part of an input device according to an embodiment of the present invention.

FIG. 2 is a drawing illustrating a configuration example of a main part of a display unit including a multi-point detection touch panel.

FIG. 3 is a drawing illustrating a configuration example of a main part of a display unit including a single-point detection touch panel.

FIG. 4 is a flow chart showing a processing flow in the input device according to an embodiment of the present invention, from a step of displaying a UI screen to a step of displaying an input image which has been optimally adjusted to be appropriate for a size of the user's hand.

FIG. 5 is a flow chart showing a processing flow in which the input device according to an embodiment of the present invention detects a touch by a user on the touch panel and eventually outputs finger images.

FIG. 6 is a flow chart showing a processing flow in which the input device according to an embodiment of the present invention finds widths of the finger images and a distance between the finger images.

FIG. 7 illustrates an example in which the present invention is embodied as an electronic keyed instrument, where (a) to (e) of FIG. 7 depict details of respective steps in the input device.

FIG. 8 is an enlarged view of the finger images depicted in (d) of FIG. 7, illustrating widths of the respective images and a distance between the images.

FIG. 9 illustrates an example in which the present invention is embodied as an on-screen keyboard, where (a) to (e) of FIG. 9 depict details of respective steps in the input device.

FIG. 10 is an enlarged view of the finger images depicted in (d) of FIG. 9, illustrating longitudinal widths and transverse widths of the respective images and distances between the images.

FIG. 11 is a flow chart showing a processing flow in the input device according to an embodiment of the invention, from a step of displaying a UI screen to a step of displaying the input images after optimally adjusting distances between the input images so as to be appropriate for a size of the user's hand.

FIG. 12 illustrates an example in which the present invention is embodied as an electronic stringed instrument, where (a) to (e) of FIG. 12 depict details of respective steps in the input device 1.

FIG. 13 is an enlarged view of the finger images depicted in (d) of FIG. 12, illustrating widths of the respective images and a distance between the images.

### DESCRIPTION OF EMBODIMENTS

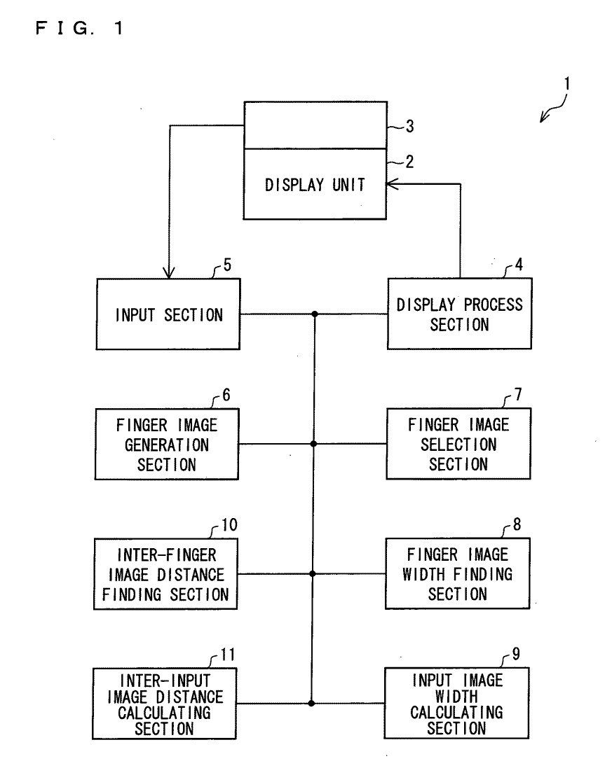

The following describes an embodiment of an input device according to the present invention with reference to FIGS. 1 to 13.

(Configuration of Input Device 1)

To begin with, described is a configuration of a main part of an input device 1 according to an embodiment of the present invention with reference to FIG. 1.

FIG. 1 is a block diagram illustrating a configuration of a main part of the input device 1 according to an embodiment of the present invention. As illustrated in FIG. 1, the input device 1 includes a display unit (display) 2, a touch panel 3, a display process section (display process means) 4, an input section 5, a finger image generation section (image generation means) 6, a finger image selection section 7, a finger image width finding section 8, an input image width calculating section (width calculating means) 9, an inter-finger image distance finding section 10, and an inter-input image distance calculating section (distance calculating means) 11. The details of the respective members will be described later.

(Configuration of Display Unit 2)

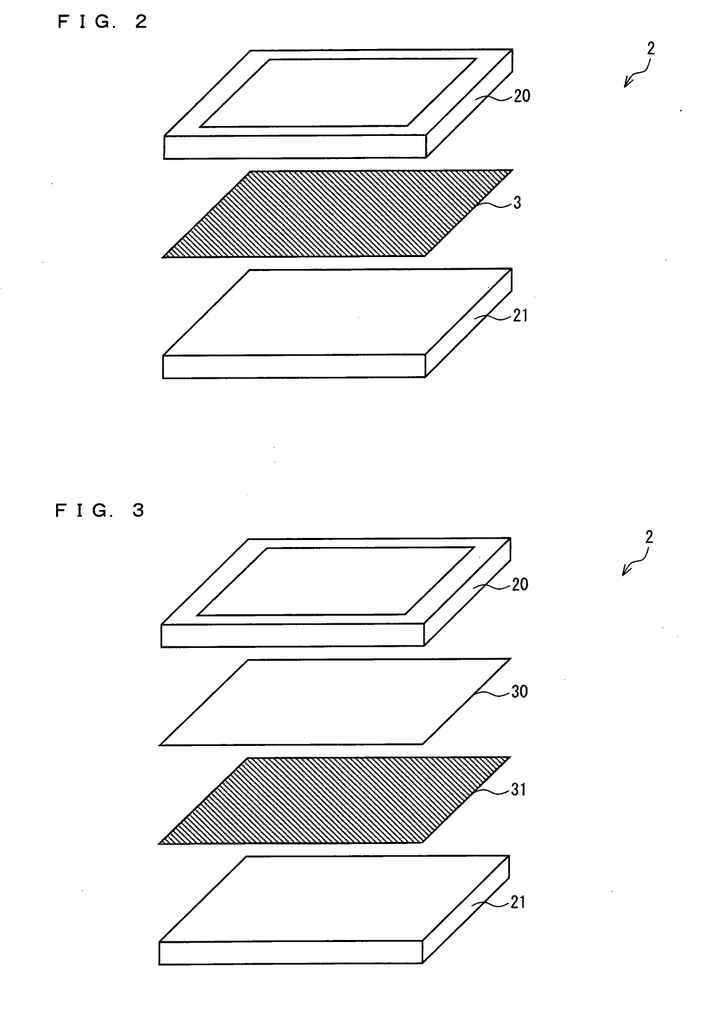

Referring to FIG. 2, described below is a configuration of the display unit 2 according to the present embodiment. FIG. 2 is a drawing illustrating a configuration example of a main part of a display unit 2 including a multi-point detection touch panel 3. As illustrated in FIG. 2, the display unit 2 includes a housing 20, a touch panel 3, and a backlight system 21. On the backlight system 21 is provided the touch panel 3, and on the touch panel 3 is further provided the housing 20. The display unit 2 is a liquid crystal display, for example. Alternatively, the display unit 2 can be a display of other type.

The backlight system 21 adjusts image display brightness of the touch panel 3. The touch panel 3 of the present embodiment is a multi-point detection touch panel. An internal configuration of the touch panel 3 is not particularly limited. However, the touch panel 3 is preferably a photo detecting touch panel. Further, the touch panel 3 may include an optical sensor, or may have other multi-point detection configuration. It is not particularly specified here. Steps performed in the touch panel 3 will be described later.

In the input device 1, the touch panel 3 may be built in the display unit 2, as described above. Alternatively, the touch panel 3 may be provided on the display unit 2.

The input device 1 may also include a plurality of display units 2. For example, the input device 1 may be a double-screened personal digital assistant including two display units 2 respectively provided with touch panels 3.

(Another Configuration Example of Display Unit 2)

Next, another configuration example of the display unit 2 is described with reference to FIG. 3. FIG. 3 is a drawing illustrating a configuration example of a main part of a display unit including a single-point detection touch panel. As illustrated in FIG. 3, the display unit 2 includes a housing 20, a touch panel 30, a liquid crystal panel 31, and a backlight system 21. In this configuration, on the backlight system 21, the liquid crystal panel 31, the touch panel 30, and the housing 20 are disposed in this order so that one is on top of the other. The touch panel 30 is a single-point detection touch panel. An internal configuration of the touch panel 30 is not particularly limited. For example, it may be a resistive touch panel, or may have other single-point detection configuration.

The following description discusses the present embodiment with reference to an example of a multi-point detection touch panel illustrated in FIG. 2.

(Example of Electronic Keyed Instrument)

First, the following describes a case where the input device 1 according to the present invention is realized as an electronic keyed instrument, with reference to FIGS. 1 and 4 to 8. An electronic keyed instrument is exemplified by an electronic piano.

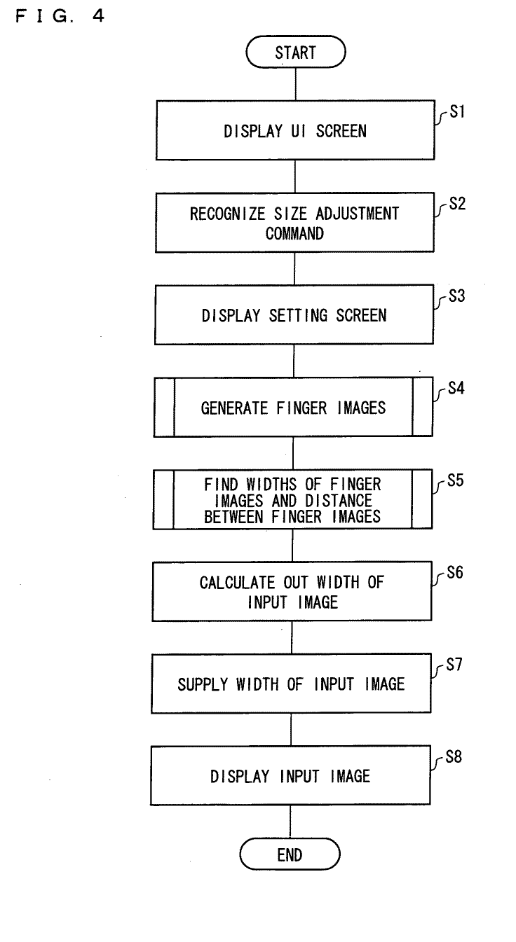

FIG. 4 is a flow chart showing a processing flow in the input device 1 according to an embodiment of the present invention, from a step of displaying a UI screen to a step of displaying an input image which has been optimally adjusted to be appropriate for a size of the user's hand. Here, the input image is represented as a key of the electronic piano.

(Configuration of Electronic Keyed Instrument)

With reference to FIG. 7, a configuration of the electronic keyed instrument is described. FIG. 7 illustrates an example in which an embodiment of the present invention is realized as an electronic keyed instrument, where (a) to (e) of FIG. 7 depict details of respective steps in the input device 1. While describing a brief overview of each drawing, a configuration of the electronic keyed instrument is explained.

In FIG. 7, (a) depicts a UI screen that the input device 1 displays in the display unit 2. This screen is an initial screen of the electronic keyed instrument that has not been particularly set by the user. The user touches the touch panel 3 which displays the electronic keyboard directly with his/her fingers to play music. On the UI screen are further displayed a button 70 and a plurality of keys 72. The keyboard depicted in (a) of FIG. 7 is made up of the plurality of keys 72. The button 70 serves for adjusting the size of the keys 72. In response to a press of the button 70 by the user, the input device 1 displays a setting screen 73 in the display unit 2, as depicted in (b) of FIG. 7. The setting screen 73 is a screen on which the user puts his/her hand 74 in order to enter widths of the respective fingers and a size of the hand so that the size of the keys 72 is adjusted. In a key display region 71, various keys that serve for adjusting volume and the like are displayed. For clarification of the following explanation, (c) and (d) of FIG. 7 depict images of the fingers of the hand 74. It is not required that the images are actually displayed in the display unit 2 so as to be visible to the user. In FIG. 7, (e) depicts the keyboard made up of the keys 72 that have been optimally adjusted to have a size that is appropriate for the hand of the user. The details of the steps corresponding to the respective drawings will be described later.

(Steps in Input Device 1 as Electronic Keyed Instrument)

As shown in FIG. 4, the input device 1 first displays the UI screen (step S1).

In step S1, the UI screen as depicted in (a) of FIG. 7 is displayed. The display process section 4 of the input device 1 first supplies a display signal for displaying the UI screen to the display section 2, as illustrated in FIG. 1.

Then, the display section 2 displays a screen in accordance with the display signal.

The input device 1 recognizes a press of the button 70 by the user as a command for a size adjustment of the keys 72 (step S2), thereby displaying a setting screen 73 for the size adjustment in the display unit 2 (step S3), as depicted in (b) of FIG. 7.

(Generation of Finger Images)

Subsequently, the input device 1 generates images of the respective fingers based on the input operation by the user's hand 74 put on the setting screen 73 depicted in (b) of FIG. 7 (step S4).

Here, with reference to FIGS. 1, 5, and 7, details of the processes carried out in step S4 are described in the following.

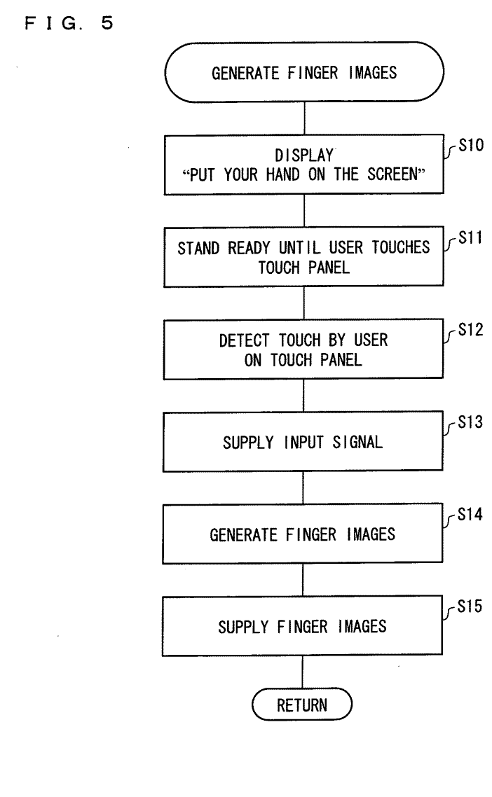

FIG. 5 is a flow chart showing a processing flow in which the input device 1 according to an embodiment of the present invention detects a touch by the user on the touch panel 3 and eventually outputs finger images.

As shown in FIG. 5, the input device 1 first displays a massage “Please put your hand on the screen” in the display unit 2 (step S10), and stands ready until the user touches the touch panel 3 (step S11). When the input device 1 detects a touch with the user's hand 74 on the setting screen 73 (step S12), as depicted in (b) of FIG. 7, the touch panel 3 supplies a detected input signal to the input section 5. The input section 5 then supplies the input signal to the finger image generation section 6 (step S13).

The finger image generation section 6 generates images of the respective fingers based on the input signal (step S14). The finger images generated here are images 75 depicted in (c) of FIG. 7.

Note that the finger image generation section 6 may generate at least an image of a first finger and an image of a second finger which is adjacent to the first finger, among a plurality of fingers that press on the touch panel 30. If, for example, the first finger is a forefinger, then the second finger is, for example, a middle finger. The finger image generation section 6 supplies the images to the finger image selection section 7 (step S15).

(Finding of Widths of Finger Images and Distance Between Finger Images)

After step S4, the input device 1 finds, based on the images 75, widths of the finger images and a distance between the finger images (step S5).

The following explains details of processes carried out in step S5 with reference to FIGS. 1, 6, 7, and 8.

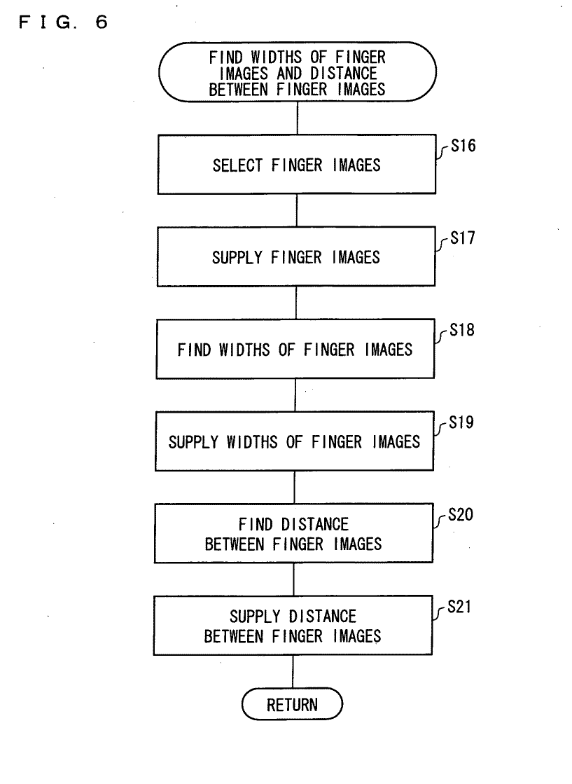

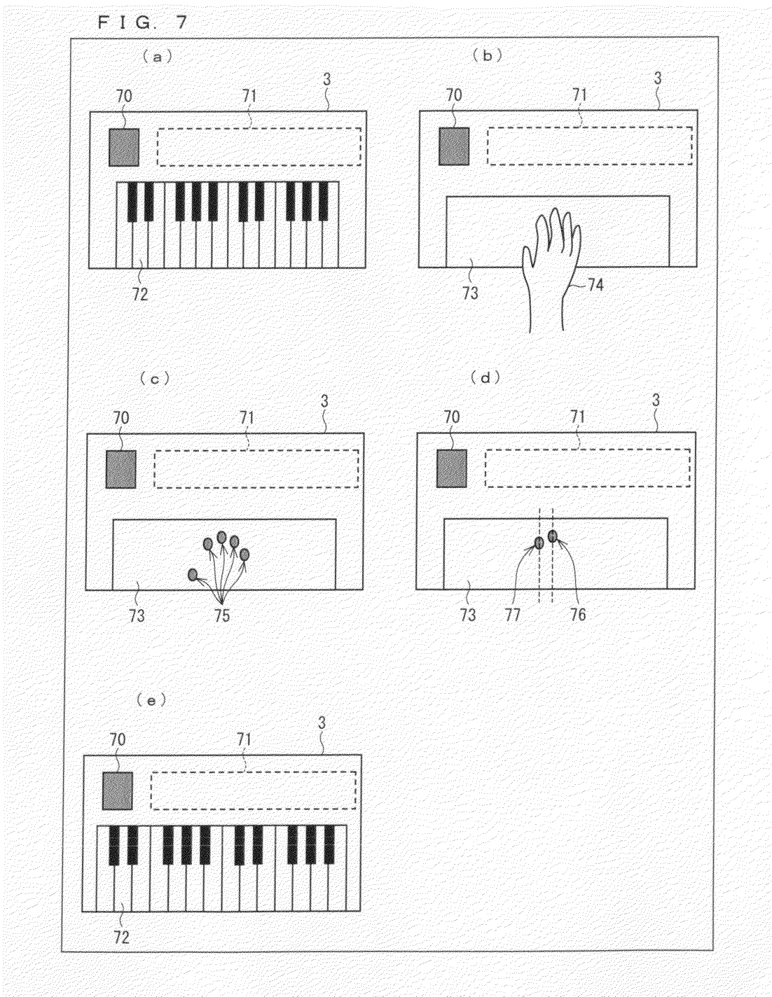

FIG. 6 is a flow chart showing a processing flow in which the input device 1 according to an embodiment of the present invention finds the widths of the finger images and the distance between the finger images.

As shown in FIG. 6, the finger image selection section 7 first selects two images from the images 75 (step S16). In FIG. 7, (d) depicts the selected finger images 76 and 77.

The finger image selection section 7 then supplies the images 76 and 77 to the finger image width finding section 8 and the inter-finger image distance finding section 10 (step S17).

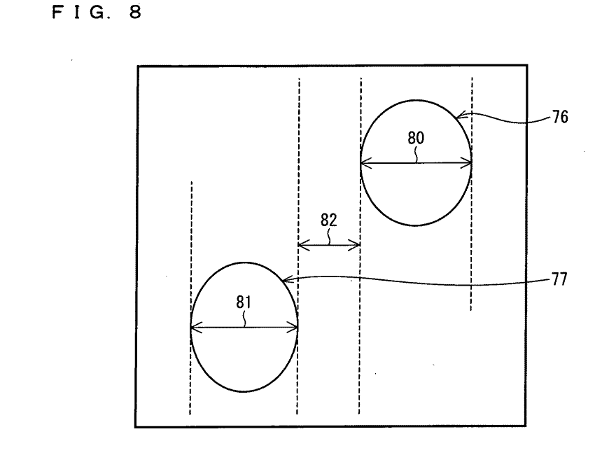

Now, steps in the finger image width finding section 8 and the inter-finger image distance finding section 10 are explained with reference to FIG. 8.

FIG. 8 is an enlarged view of the images 76 and 77 depicted in (d) of FIG. 7, illustrating widths of the respective images and a distance between the images. As illustrated in FIG. 8, the finger image width finding section 8 finds a width 80 of the image 76 and a width 81 of the image 77 (step S18). The result is supplied to the input image width calculating section 9 (step S19). Meanwhile, the inter-finger image distance finding section 10 finds a distance 82 between the images 76 and 77 (step S20). The result is supplied to the input image width calculating section 9 (step S21).

(Calculation of Input Image Width)

After step S5, the input image width calculating section 9 calculates out a width of an input image based on the supplied widths 80 and 81 and the supplied distance 82 (step S6). Here, the input image is represented as the key 72 depicted in (e) of FIG. 7. Specifically, the input image width calculating section 9 divides a sum of the widths 80 and 81 and the distance 82 by 2 to calculate out the width of the key 72.

The input image width calculating section 9 supplies, to the display process section 4, data indicative of the width of the key 72 thus calculated out (step S7). The display process section 4 supplies, to the display unit 2, a signal of the input image adjusted to have the width corresponding to the supplied data. The touch panel 3 in the display unit 2 displays an input image based on the input signal (step S8).

Thus, a keyboard as depicted in (e) of FIG. 7, which is made up of a plurality of keys 72 each adjusted to have a size that is appropriate for the size of the user's hand, is displayed in the display unit 2. In response to pressing of the keys by the user with his/her finger, the electronic keyed instrument produces sounds. Each of the keys 72 is adjusted to have a width that is appropriate for the width of the user's finger. As such, the user can play music without playing a wrong note by, for example, pressing two keys simultaneously by mistake. Further, the keys 72 are arranged to correspond to the spaces between the fingers of the hand naturally put on the keyboard. This allows the user to play music comfortably. Moreover, it is not necessary for the user to put his/her hand on the keyboard repeatedly for minor adjustments of the width of the key. The size of the keyboard can be adjusted by a single setting so as to be appropriate for the size of the user's hand.

(Example of On-Screen Keyboard)

Referring now to FIGS. 1, 4, 9, and 10, the following describes a case where the input device 1 according to the present invention is realized as an on-screen keyboard.

In the following, a detailed explanation is omitted with respect to the steps that are common to those in the aforementioned embodiment where the input device 1 is realized as the foregoing electronic keyed instrument.

Here, the input image in FIG. 4 is represented as a key of the on-screen keyboard.

(Configuration of On-Screen Keyboard)

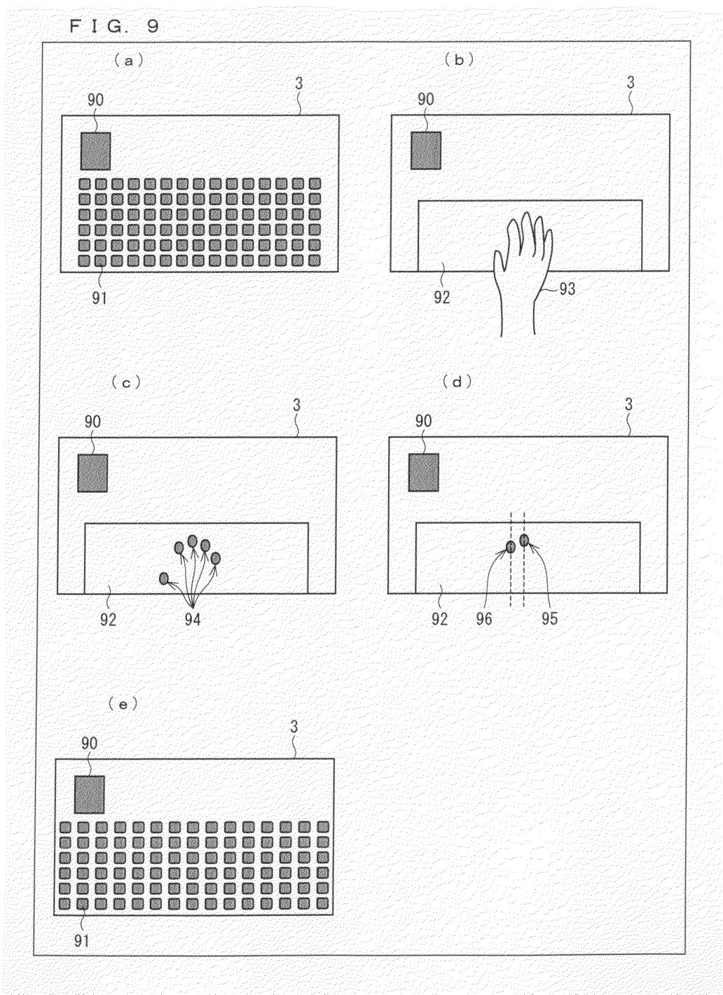

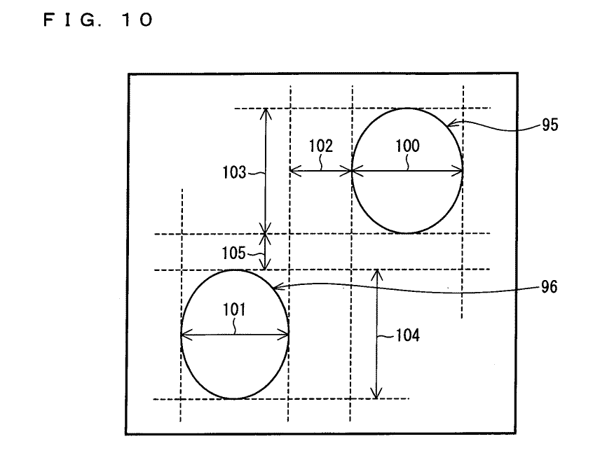

With reference to FIG. 9, a configuration of the on-screen keyboard is described. FIG. 9 illustrates an example in which the present invention is embodied as an on-screen keyboard, where (a) to (e) of FIG. 9 depict details of respective steps in the input device 1. While describing a brief overview of each drawing, a configuration of the on-screen keyboard is explained.

In FIG. 9, (a) depicts a UI screen that the input device 1 displays in the display unit 2. This screen is an initial screen of the on-screen keyboard that has not been particularly set by the user. The user touches the touch panel 3 which displays the on-screen keyboard directly with his/her fingers to perform an input operation. On the UI screen are further displayed a button 90 and a plurality of keys 91. The keyboard depicted in (a) of FIG. 9 is made up of the plurality of keys 91. The button 90 serves for adjusting the size of the keys 91. In response to a press of the button 90 by the user, the input device 1 displays a setting screen 92 in the display unit 2, as depicted in (b) of FIG. 9. The setting screen 92 is a screen on which the user puts his/her hand 93 in order to enter widths of the respective fingers and a size of the hand so that the size of the keys 91 is adjusted. For clarification of the following explanation, (c) and (d) of FIG. 9 depict images of the fingers of the hand 93. It is not required that the images are actually displayed in the display unit 2 so as to be visible to the user. In FIG. 9, (e) depicts the keyboard that has been optimally adjusted to have a size that is appropriate for the hand of the user. The details of the steps corresponding to the respective drawings will be described later.

(Steps in Input Device 1 as On-Screen Keyboard)

As shown in FIG. 4, the input device 1 first displays the UI screen (step S1).

In step S1, the UI screen as depicted in (a) of FIG. 9 is displayed. The input device 1 then recognizes a press of the button 90 by the user as a command for a size adjustment of the keys 91 (step S2), thereby displaying a setting screen 92 for the size adjustment in the display unit 2 (step S3), as illustrated in (b) of FIG. 9.

(Generation of Finger Images)

Subsequently, the input device 1 generates images of the respective fingers based on the input operation by the user's hand 93 put on the setting screen 92 depicted in (b) of FIG. 9 (step S4). The details of the generation process of the finger images in step S4 have already been described with reference to FIG. 5. As such, the description is omitted.

The finger images generated in step S4 are images 94 shown in (c) of FIG. 9.

(Finding of Widths of Finger Images and Distances Between Finger Images)

After step S4, the input device 1 finds, based on the images 94, widths of the finger images and distances between the finger images (step S5).

The following explains details of processes carried out in step S5 with reference to FIGS. 1, 6, 9, and 10.

As shown in FIG. 6, the finger image selection section 7 first selects two images from the images 94 (step S16). In FIG. 9, (d) depicts the selected finger images 95 and 96.

The finger image selection section 7 then supplies the images 95 and 96 to the finger image width finding section 8 and the inter-finger image distance finding section 10 (step S17).

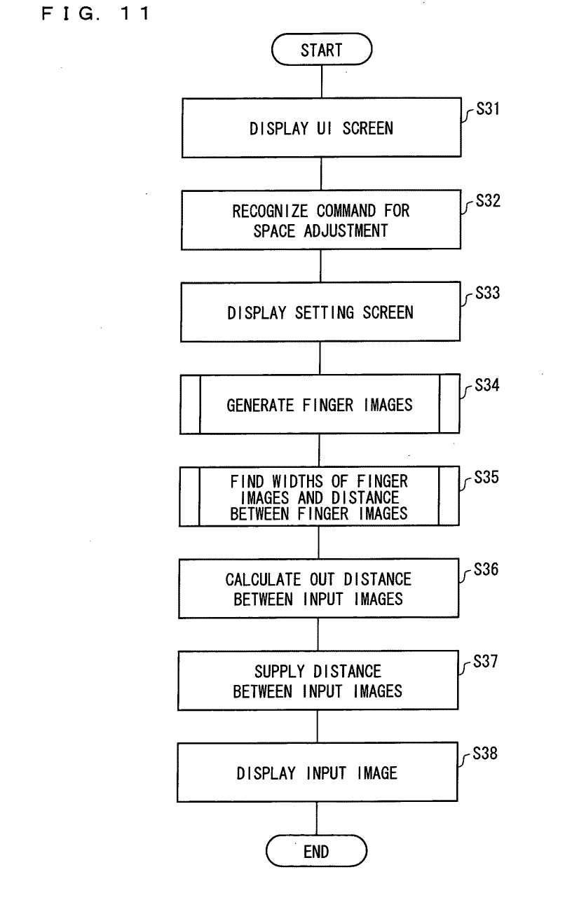

Now, steps in the finger image width finding section 8 and the inter-finger image distance finding section 10 are explained with reference to FIG. 10.

FIG. 10 is an enlarged view of the images 95 and depicted in (d) of FIG. 9, illustrating longitudinal widths and transverse widths of the respective images and distances between the images. As illustrated in FIG. 10, the finger image width finding section 8 finds a transverse width 100 of the image 95, a transverse width 101 of the image 96, a longitudinal width 103 of the image 95, and a longitudinal width 104 of the image 96 (step S18). The result is supplied to the input image width calculating section 9 (step S19). Meanwhile, the inter-finger image distance finding section 10 finds a longitudinal distance 105 and a transverse distance 102 between the images 95 and 96 (step S20). The result is supplied to the input image width calculating section 9 (step S21).

(Calculation of Input Image Width)

After step S5, the input image width calculating section 9 calculates out a width of an input image based on the supplied widths 100, 101, 103, and 104 and the supplied distances 102 and 105 (step S6). Here, the input image is represented as the key 91 depicted in (e) of FIG. 9. More specifically, the input image width calculating section 9 divides a sum of the widths 100 and 101 and the distance 102 by 2 so as to calculate out the transverse width of the key 91. Further, the input image width calculating section 9 divides a sum of the widths 103 and 104 and the distance 105 by 2 to calculate out the longitudinal width of the key 91.

The input image width calculating section 9 supplies, to the display process section 4, data indicative of the longitudinal width and the transverse width of the key 91 thus calculated out (step S7). The display process section 4 supplies, to the display unit 2, a signal of the input image adjusted in size in consideration of the longitudinal width and the transverse width thus inputted. The touch panel 3 in the display unit 2 displays an input image based on the input signal (step S8).

In this way, the key 91 as depicted in (e) of FIG. 9, which has been adjusted to have a size that is appropriate for the size of the user's hand, is displayed in the display unit 2. This allows the user to comfortably operate the keyboard.

Thus, a keyboard as depicted in (e) of FIG. 9, which is made up of the keys 91 each adjusted to have a size that is appropriate for the size of the user's hand, is displayed in the display unit 2. In response to pressing of the keyboard by the user with his/her finger, the on-screen keyboard carries out necessary steps. Each of the keys 91 is adjusted to have a width that is appropriate for the width of the user's finger. As such, the user can operate the keyboard with no fear of making an error in touching the keys by, for example, pressing two keys simultaneously by mistake. Further, the keys 91 are arranged to correspond to the spaces between the fingers of the hand naturally put on the keyboard. This allows the user to comfortably operate the keyboard. Moreover, it is not necessary for the user to put his/her hand on the keyboard repeatedly for minor adjustments of the size of the key. The size of the keyboard can be adjusted by a single setting so as to be appropriate for the size of the user's hand.

(Example of Electronic Stringed Instrument)

Referring now to FIGS. 1 and 11 to 13, the following describes a case where the input device 1 according to the present invention is realized as an electronic stringed instrument. An electronic stringed instrument is exemplified by an electronic guitar.

In the following, a detailed explanation is omitted with respect to the steps that are common to those in the case where the input device 1 is realized as the foregoing electronic keyed instrument and on-screen keyboard.

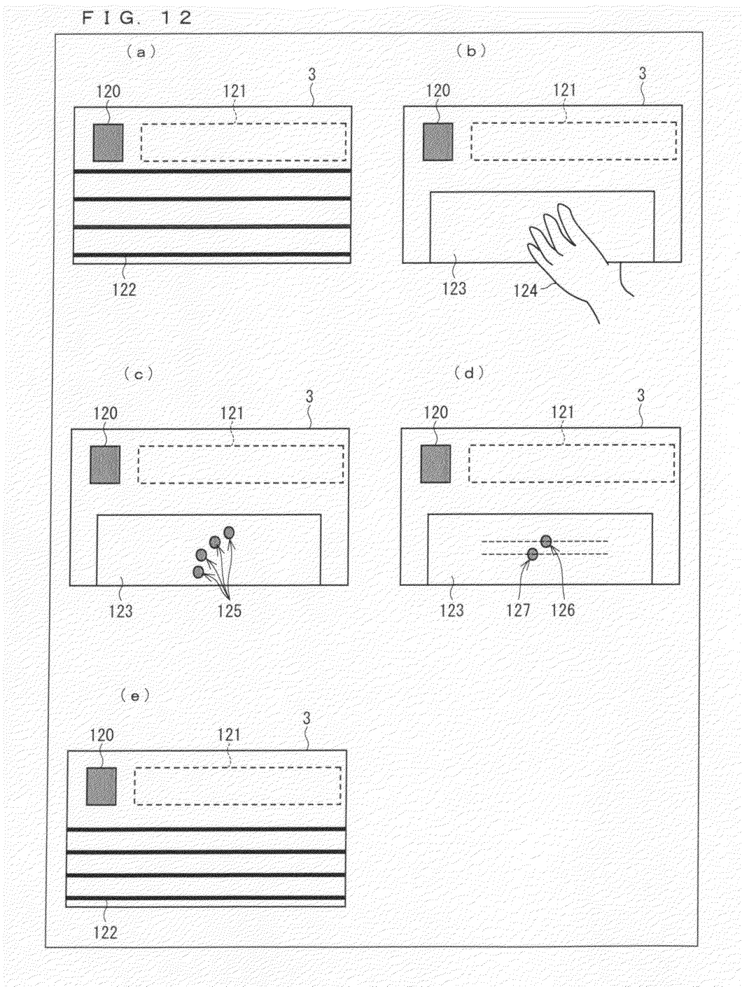

FIG. 11 is a flow chart showing a processing flow in the input device 1 according to an embodiment of the present invention, from a step of displaying a UI screen to a step of displaying an input image which has been optimally adjusted to be appropriate for a size of the user's hand. Here, the input image is represented as a string of the electronic guitar.

(Configuration of Electronic Stringed Instrument)

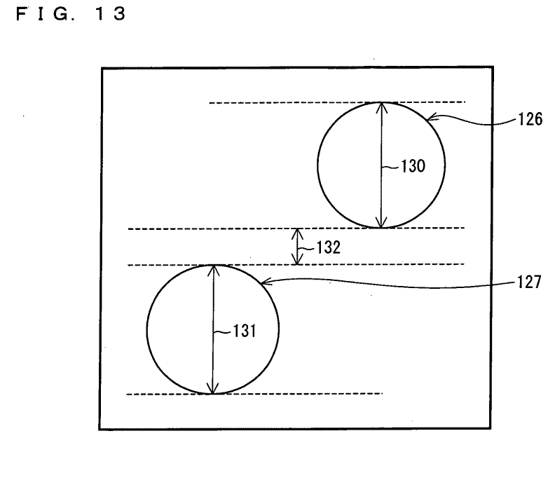

With reference to FIG. 12, a configuration of the electronic stringed instrument is described. FIG. 12 illustrates an example in which the present invention is embodied as an electronic stringed instrument, where (a) to (e) of FIG. 12 depict details of respective steps in the input device 1. While describing a brief overview of each drawing, a configuration of the electronic stringed instrument is explained.

In FIG. 12, (a) depicts a UI screen that the input device 1 displays in the display unit 2. This screen is an initial screen of the electronic stringed instrument that has not been particularly set by the user. On the UI screen are further displayed a button 120 and a plurality of strings 122. The button 120 serves for adjusting the spaces between the strings 122. In response to a press of the button 120 by the user, the input device 1 displays a setting screen 123 in the display unit 2, as depicted in (b) of FIG. 12. The setting screen 123 is a screen on which the user puts his/her hand 124 in order to enter widths of the respective fingers and a size of the hand so that the spaces between the stings 122 are adjusted. In a key display region 121, various keys that serve for adjusting volume and the like are displayed. For clarification of the following explanation, (c) and (d) of FIG. 12 depict images of the fingers of the hand 124. It is not required that the images are actually displayed in the display unit 2 so as to be visible to the user. In FIG. 12, (e) depicts the strings 122 arranged to have such spaces therebetween that are adjusted to be appropriate for the hand of the user. The details of the steps corresponding to the respective drawings will be described later.

(Steps in Input Device 1 as Electronic Stringed Instrument)

As shown in FIG. 11, the input device 1 first displays the UI screen (step S31).

In step S31, the UI screen as depicted in (a) of FIG. 12 is displayed. The input device 1 then recognizes a press of the button 120 by the user as a command for a space adjustment between the strings 122 (step S32), thereby displaying a setting screen 123 for the space adjustment in the display unit 2 (step S33), as depicted in (b) of FIG. 12.

(Generation of Finger Images)

Subsequently, the input device 1 generates images of the respective fingers based on the input operation by the user's hand 124 put on the setting screen 123 depicted in (b) of FIG. 12 (step S34). The details of the generation process of the finger images in step S34 have already been described with reference to FIG. 5. As such, the description is omitted.

The finger images generated in step S34 are images 125 shown in (c) of FIG. 12.

(Finding of Widths of Finger Images and distance Between Finger Images)

After step S34, the input device 1 finds, based on the images 125, widths of the finger images and a distance between the finger images (step S35).

The following explains details of processes carried out in step S35 with reference to FIGS. 1, 6, and 11 to 13.

As shown in FIG. 6, the finger image selection section 7 first selects two images from the images 125 (step S16). In FIG. 12, (d) depicts the selected finger images 126 and 127.

The finger image selection section 7 then supplies the images 126 and 127 to the finger image width finding section 8 and the inter-finger image distance finding section 10 (step S17).

Nov, steps in the finger image width finding section 8 and the inter-finger image distance finding section 10 are explained with further reference to FIG. 13.

FIG. 13 is an enlarged view of the images 126 and 127 depicted in (d) of FIG. 12, illustrating widths of the respective images and a distance between the images. As illustrated in FIG. 13, the finger image width finding section 8 finds a width 130 of the image 126 and a width 131 of the image 127 (step S18). The result is supplied to the inter-input image distance calculating section 11 (step S19). Meanwhile, the inter-finger image distance finding section 10 finds a distance 132 between the images 126 and 127 (step S20). The result is supplied to the inter-input image distance calculating section 11 (step S21).

(Calculation of Input Image Width)

After step S35, the inter-input image distance calculating section 11 finds a distance between the input images based on the supplied widths 130 and 131 and the supplied distance 132. Here, the input image is represented as the string 122 depicted in (e) of FIG. 12. Specifically, the inter-input image distance calculating section 11 divides a sum of the widths 130 and 131 and the distance 132 by 2 to calculate out the distance to be provided between adjacent strings among the strings 122 (step S36).

The inter-input image distance calculating section supplies data indicative of the distance to be provided between the strings 122 thus found to the display process section 4 (step S37). The display process section 4 supplies a signal of the input image, in which the supplied distance is provided, to the display unit 2. The touch panel 3 in the display unit 2 displays an input image based on the input signal (step S38).

Thus, the strings 122 as depicted in (e) of FIG. 12, which are arranged to be spaced apart from each other so as to be appropriate for the size of the user's hand, are displayed in the display unit 2. In response to pressing of the strings by the user with his/her finger, the electronic stringed instrument produces sounds. Since the strings 122 are arranged to be spaced apart from each other so as to be appropriate for the widths of the user's fingers, the user can play music with no fear of making an error in touching the strings by, for example, pressing two strings simultaneously by mistake. Further, the strings 122 are arranged to correspond to the spaces between the fingers of the hand naturally put on the strings. This allows the user to play music comfortably. Moreover, it is not necessary for the user to put his/her hand on the strings repeatedly for minor adjustments of the spaces between the strings. The spaces between the strings can be adjusted by a single setting so as to be appropriate for the size of the user's hand.

(Single-Point Input)

The present invention can be realized also in a configuration which includes a single-point detection touch panel that has been described with reference to FIG. 3. In this case, the generation process of the finger images, which has been described above with reference to FIG. 5, is different from that in the case where the multi-point detection touch panel is used only in the following:

In step S10 of FIG. 5, the input device 1 displays in the display unit 2 a message “Please put your fingers on the screen one by one”, instead of the message “Please put your hand on the screen”. As such, in step S12, the input device 1 does not detect a touch with a plurality of fingers simultaneously, but detects touches with the respective fingers one by one, instead.

The other steps that are followed by this step and the steps that follow this step are the same as those in the case where the multi-point detection touch panel is used, and the same effects are produced.

Note that the present invention is not limited to the foregoing embodiments. Those skilled in the art may vary the present invention in many ways without departing from the claims. That is, a new embodiment may be provided from a combination of technical means arbitrarily altered within the scope of claims.

(Program and Storage Medium)

Finally, the blocks included in the input device 1 may be realized by way of hardware or software as executed by a CPU (Central Processing Unit) as follows:

The input device 1 includes a CPU and memory devices (storage media). The CPU executes instructions in programs realizing the functions. The storage devices include a ROM (Read Only Memory) which contains programs, a RAM (Random Access Memory) to which the programs are loaded in an executable form, and a memory containing the programs and various data. With this configuration, the objective of the present invention can also be achieved by a predetermined storage medium.

The storage medium may record program code (executable program, intermediate code program, or source program) of the program for the input device 1 in a computer readable manner. The program is software realizing the aforementioned functions. The storage medium is provided to the input device 1. The input device 1 (or CPU, MPU) that serves as a computer may retrieve and execute the program code contained in the provided storage medium.

The storage medium that provides the input device 1 with the program code is not limited to the storage medium of a specific configuration or kind. The storage medium may be, for example, a tape, such as a magnetic tape or a cassette tape; a magnetic disk, such as a floppy (Registered Trademark) disk or a hard disk, or an optical disk, such as CD-ROM/MO/MD/DVD/CD-R; a card, such as an IC card (memory card) or an optical card; or a semiconductor memory, such as a mask ROM/EPROM/EEPROM/flash ROM.

The object of the present invention can also be achieved by arranging the input device 1 to be connectable to a communications network. In that case, the aforementioned program code is delivered to the input device 1 over the communications network. The communication network may be able to deliver the program codes to the input device 1, and is not limited to the communications network of a particular kind or form. The communications network may be, for example, the Internet, an intranet, extranet, LAN, ISDN, VAN, CATV communications network, virtual dedicated network (virtual private network), telephone line network, mobile communications network, or satellite communications network.

The transfer medium which makes up the communications network may be any medium that can transfer the program code, and is not limited to a transfer medium of a particular configuration or kind. The transfer medium may be, for example, wired line, such as IEEE 1394, USB (Universal Serial Bus), electric power line, cable TV line, telephone line, or ADSL (Asymmetric Digital Subscriber Line); or wireless, such as infrared radiation (IrDA, remote control), Bluetooth (Registered Trademark), 802.11 wireless, HDR, mobile telephone network, satellite line, or terrestrial digital network. The present invention can also be realized in the mode of a computer data signal embedded in a carrier wave in which data signal the program code is embodied electronically.

### INDUSTRIAL APPLICABILITY

The present invention is widely available as an input device including a touch panel. For example, the present invention can be realized as an input device mounted on an electronic music device such as an electronic piano and an electronic guitar, a mobile telephone terminal, a personal digital assistant (PDA), or a PMP (portable media player).

### REFERENCE SIGNS LIST

1 Input Device
2 Display Unit (Display)
3 Touch Panel
4 Display Process Section (Display Process Means)
5 Input Section
6 Finger Image Generation Section (Image Generation Means)
7 Finger Image Selection Section
8 Finger Image Width Finding Section
9 Input Image Width Calculating Section (Width Calculating Means)
10 Inter-Finger Image Distance Finding Section
11 Inter-Input Image Distance Calculating Section (Distance Calculating Means)
20 Housing
21 Backlight System
30 Touch Panel
31 Liquid Crystal Panel
70, 90, 120 Button
71, 121 Key Display Region
72 Key
73, 92, 123 Setting Screen
74, 93, 124 Hand
75, 94, 125 Image
76, 77, 95,96,126,127 Image
80, 81, 100, 101, 103, 104, 130, 131 Width
82, 102, 105, 132 Distance
91 Key
122 String

1. An input device including a display and a touch panel provided to the display, comprising:
image generation means for generating respective images of, among a plurality of fingers pressing on the touch panel, a first finger and a second finger adjacent to the first finger; and
display process means for displaying on the display a plurality of input images corresponding to a distance between two images generated by the image generation means and respective sizes of the two images.

2. The input device according to claim 1, further comprising:
width calculating means for calculating out a given width of the plurality of input images based on the distance and the sizes,
the display process means displaying the plurality of input images each having the width calculated out by the width calculating means.

3. The input device according to claim 2, wherein:
the width calculating means calculates out, based on the distance and the sizes, longitudinal widths and transverse widths of the plurality of input images, respectively, and
the display process means displays the plurality of input images respectively having the longitudinal widths and the transverse widths calculated out by the width calculating means.

4. The input device according to claim 1, further comprising:
distance calculating means for calculating out, based on the distance and the sizes, a distance between adjacent input images among the plurality of input images,
the display process means displaying the plurality of input images so as to space the input images apart from each other at the distance calculated out by the distance calculating means.

5. The input device according to claim 1, wherein:
the touch panel is a photo detecting touch panel.

6. The input device according to claim 1, wherein:
the display is a liquid crystal display.

7. The input device according to claim 1, wherein:
the input device is a personal digital assistant or a mobile telephone terminal.

8. An input method executed by an input device which includes a display and a touch panel provided to the display, comprising the steps of:
generating respective images of, among a plurality of fingers pressing on the touch panel, a first finger and a second finger adjacent to the first finger; and
displaying on the display a plurality of input images corresponding to a distance between two images generated by the image generation means and respective sizes of the two images.

9. A program for operating an input device according to claim 1,
the program causing a computer to function as each of the means.

10. A computer readable storage medium in which a program according to claim 9 is stored.
